(19) United States
(12) Patent Application Publication
(10) Pub. No.: US 2020/0026453 A1
(43) Pub. Date: Jan. 23, 2020

(54) METHOD AND SYSTEM FOR DYNAMICALLY EXPANDING A STORAGE SYSTEM

(71) Applicants: MICHAEL J RIESCHL, EAGAN, MN (US); LINDA J BROCK, EAGAN, MN (US)

(72) Inventors: MICHAEL J RIESCHL, EAGAN, MN (US); LINDA J BROCK, EAGAN, MN (US)

(73) Assignee: Unisys Corporation, Blue Bell, PA (US)

(21) Appl. No.: 16/041,909

(22) Filed: Jul. 23, 2018

(51) Int. Cl. G06F 3/06; G06F 17/30

(52) U.S. Cl. CPC G06F 3/0647; G06F 17/30091; G06F 3/0689; G06F 3/0604

(57) ABSTRACT

A method and system for migrating data from a source mass storage device to a destination mass storage device within a system, The method includes changing the destination mass storage device from an unavailable for operation (DN) state to a reserved for data migration (RV) state, performing a disk copy operation from the source mass storage device to the destination mass storage device, changing the destination mass storage device from the reserved for data migration (RV) state to an available for operation (UP) state, changing the source mass storage device from an available for operation (UP) state to an unavailable for operation (DN) state, performing an Expand Disk operation within the destination mass storage device to expand the size of data storage capacity of the destination mass storage device from the smaller data storage capacity of the source mass storage device, and removing the source mass storage device from the system.

### BACKGROUND

### Field

The instant disclosure relates generally to storage systems and devices, such as hard drive storage systems and devices, and in particular to methods and systems for expanding a hard drive storage system or device.

### Description of the Related Art

When a computing device user migrates data from one mass storage device to another mass storage device, e.g., replacing an old hard drive device with a new hard drive device, the data migration operation often forces the user to define the new mass storage device with a much larger track capacity than the previous mass storage device. Typically, this requirement is driven by the configuration rules of the vendor of the new mass storage device.

Computing device users often do not migrate data from one mass storage device to another mass storage device by reloading the original data from one or more backup sources. Rather, computing device users typically execute an operating system command, such as the diskcopy (DC) command. Alternatively, computing device users employ a data replication method that facilitates data replication through a storage area network or an Internet Protocol (IP) network. In both cases, the original mass storage device is copied bit-wise to the destination mass storage device. However, if the capacity of the destination mass storage device is larger than the capacity of the source mass storage device, the destination mass storage device takes on the characteristics of the source mass storage device, including the smaller data capacity of the source mass storage device. Also, the final step in both of these conventional data migration methods is a reboot of the system, which often is undesirable in large computing systems.

There is a need for a method and system to expand the internal operating system data structure to make use of larger mass storage device capacities.

### SUMMARY

Disclosed is a method and system for migrating data from a source mass storage device to a destination mass storage device within a system. The method includes changing the destination mass storage device from an unavailable for operation (DN) state to a reserved for data migration (RV) state, performing a disk copy operation from the source mass storage device to the destination mass storage device, changing the destination mass storage device from the reserved for data migration (RV) state to an available for operation (UP) state, changing the source mass storage device from an available for operation (UP) state to an unavailable for operation (DN) state, performing an Expand Disk operation within the destination mass storage device to expand the size of data storage capacity of the destination mass storage device from the smaller data storage capacity of the source mass storage device, and removing the source mass storage device from the system.

### BRIEF DESCRIPTION OF THE DRAWINGS

FIG. 1 is a schematic view of a data migration operation from a source mass storage device to a destination mass storage device;

FIG. 2 is a flow diagram of a method for migrating data from a source mass storage device to the destination storage device, according to an embodiment;

FIG. 3 is an example screenshot for choosing a user operating system during a data migration operation;

FIG. 4 is an example screenshot showing the user selected source disk/drive and for choosing a destination disk/drive during a data migration operation;

FIG. 5 is an example screenshot showing cloning options during a data migration operation;

FIG. 6 is an example screenshot showing partition properties during a data migration operation;

FIG. 7 is an example screenshot showing partition properties, with a resized partition, during a data migration operation, according to an embodiment; and

FIG. 8 is a flow diagram of a method for dynamically expanding the destination mass storage device as part of the data migration method of FIG. 2, according to an embodiment.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting, and merely set forth some of the many possible embodiments for the claimed invention.

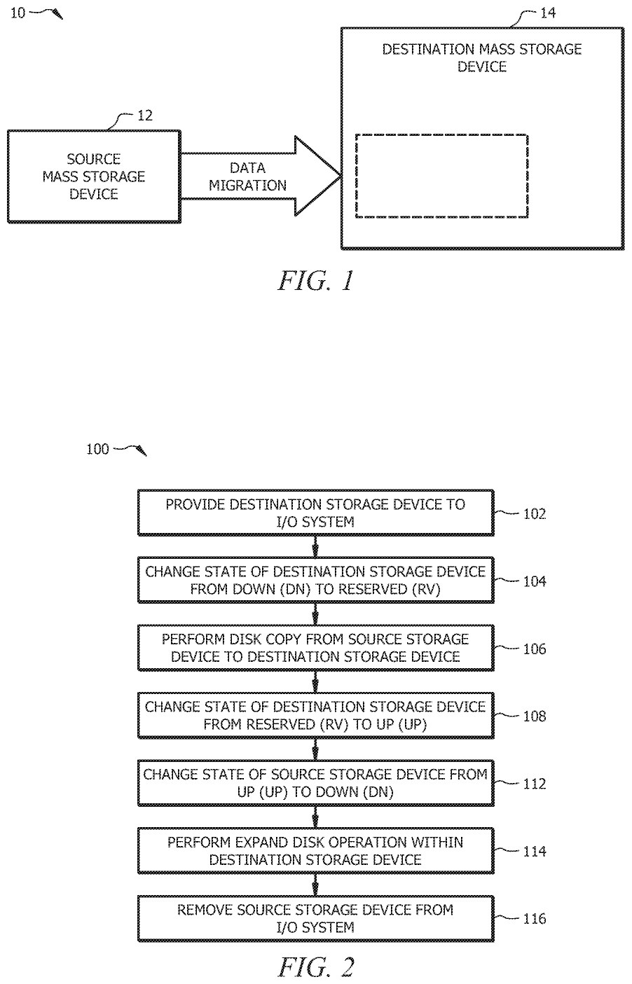

FIG. 1 is a schematic view 10 of a data migration operation from a source mass storage device 12 to a destination mass storage device 14. As discussed hereinabove, in many conventional operating systems, if the data storage capacity of the destination mass storage device 14 is larger than the data storage capacity of the source mass storage device 12, the destination mass storage device 14 takes on the characteristics of the source mass storage device 12, including the smaller data storage capacity of the source mass storage device 12.

Also, in many conventional operating systems, migrating from a source mass storage device (e.g., an existing computer system hard drive) to a destination mass storage device (e.g., a new computer system hard drive) requires stopping the system and rebooting the system at least once. For example, using a Linux operating system, migrating from a source mass storage device to a larger destination mass storage device involves the following steps:

1. Creating the partition layout on the destination mass storage device

2. Booting from the system

3. Mounting the source mass storage device partition(s) to be copied from

4. Mounting the destination mass storage device partition(s) to receive files

5. Copying the files from the source mass storage device partition(s) to the destination mass storage device partition(s)

6. Installing a boot loader on the destination mass storage device

7. Updating the configuration file that contains information of all partitions and storage devices (i.e., fstab or /etc/fstab)

8. Rebooting the system to test if the migration was successful

Using an MS Windows operating system, migrating from a source mass storage device to a destination mass storage device involves the following steps:

1. Creating the partition layout on the destination mass storage device

2. Booting the system

3. Cloning the source mass storage device using MS Windows cloning software (this step involves selecting the system drive and expanding the selected system drive to fill up the new unallocated space between the end of the system partition and the beginning of the relocated recovery partition)

4. Booting from the destination mass storage device (this step involves powering down the computer system, removing the source mass storage device, inserting the destination mass storage device into the same socket, and powering up the computer system)

However, as discussed hereinabove, rebooting a computer system, especially a relatively large computer system, is undesirable.

FIG. 2 is a flow diagram of a method 100 for migrating data from a source mass storage device to the destination storage device, according to an embodiment. As will be discussed in greater detail hereinbelow, the data migration method 100 includes a method for dynamically expanding the destination mass storage device as part of the data migration method, according to an embodiment.

The method 100 includes a step 102 of providing a destination mass storage device to an input/output (I/O) system, The step 102 involves inserting new larger destination mass storage device(s) into the input/output (I/O) system, e.g., if the partition file contains unused disk subsystems.

The method 100 also includes a step 104 of changing the state of the destination mass storage device(s) from down (ON) to reserved (RV). A down (DN) state means that the destination mass storage device is unavailable or inaccessible for operation within the system, e.g., unavailable for data reading and writing. A reserved (RV) state means that the destination mass storage device is reserved within the system, e.g., reserved for subsequent data migration.

The method 100 also includes a step 106 of performing a disk copy operation from the source mass storage device to the destination mass storage device. The disk copy step 106 involves a bit to bit disk copy of data from the source mass storage device to the destination mass storage device, e.g., using a diskcopy (DC) command or other appropriate disk copy command or function. It should be noted that a conventional disk copy operation results in the destination mass storage device (which typically has a larger data storage capacity than the source mass storage device) taking on the data storage characteristics of the source mass storage device. Therefore, if the source mass storage device has a smaller data storage capacity than the destination mass storage device, the destination mass storage device typically will take on the smaller data storage capacity of the source mass storage device.

The method 100 also includes a step 108 of changing the state of the destination mass storage device(s) from a reserved (RV) state to up (UP) state. An up (UP) state means that the destination mass storage device is available for operation within the system, e.g., available for data reading and writing. Once the disk copy operation (step 106) has been performed, the state of the destination mass storage device is changed from being reserved for data migration to being available for operation within the system.

The method 100 also includes a step 112 of changing the state of the source mass storage device(s) from an up (UP) state to a down (DN) state. Once the disk copy operation (step 106) has been performed, the state of the source mass storage device is changed from being available within the system to being unavailable within the system.

The method 100 also includes a step 114 of executing or performing an EXPAND or Expand Disk operation within the destination mass storage device(s), according to an embodiment of the invention. As noted hereinabove, the disk copy operation typically results in the destination mass storage device taking on the (smaller) data storage capacity of the source mass storage device. As will be discussed in greater detail hereinbelow, the EXPAND or Expand Disk operation dynamically expands the size of the destination mass storage device(s), as seen by the operating system, from the smaller data storage capacity of the source mass storage device to the larger data storage capacity of the destination mass storage device.

The method 100 also includes a step 116 of removing the source mass storage device(s) from the I/O system. Once the data migration from the source mass storage device to the destination mass storage has been completed, and the size of the destination mass storage device has been expanded (step 114), the source mass storage device is removed from the I/O system.

According to an embodiment, the use of the inventive EXPAND or Expand Disk operation to expand the size of the destination mass storage device(s) allows the migration from a source mass storage device to a larger destination mass storage device, without the larger destination mass storage device taking on the characteristics of the smaller source mass storage device. Furthermore, according to an embodiment, the migration from a source mass storage device to a larger destination mass storage device is performed without requiring the computer system to be rebooted.

Conventionally, migrating from a source (existing) mass storage device to a destination (new) mass storage device (e.g., upgrading a computer system's hard drive) can be relatively difficult and laborious. Typically, such migration involves backing up all documents and files, removing the existing hard drive, physically installing the new hard drive, formatting the new hard drive, reinstalling the computer system's operating system (OS) and programs, and modifying or adjusting the operating system and programs so that they exist as they did before the hard drive migration.

Alternatively, migrating from an existing hard drive to a new hard drive can be accomplished by cloning the existing hard drive. Typically, migration will be from a smaller existing hard drive to a larger new hard drive, although cloning also works for migrating from a larger existing hard drive to a smaller new hard drive. Cloning involves the use of a suitable cloning program or software. Also, as part of the cloning operation, a recovery disk typically is created on an external mass storage device, such as a USB (Universal Serial Bus) flash memory device or a writeable compact disk,

Initially, the new hard drive is coupled or connected to the existing hard drive. In a desktop computer system, the new hard drive can be connected directly to the motherboard of the computer system, e.g., via one or more Serial ATA (SATA) interface ports, For a laptop computer system, the new hard drive can be connected to the laptop computer system via a USB adapter or other suitable connection.

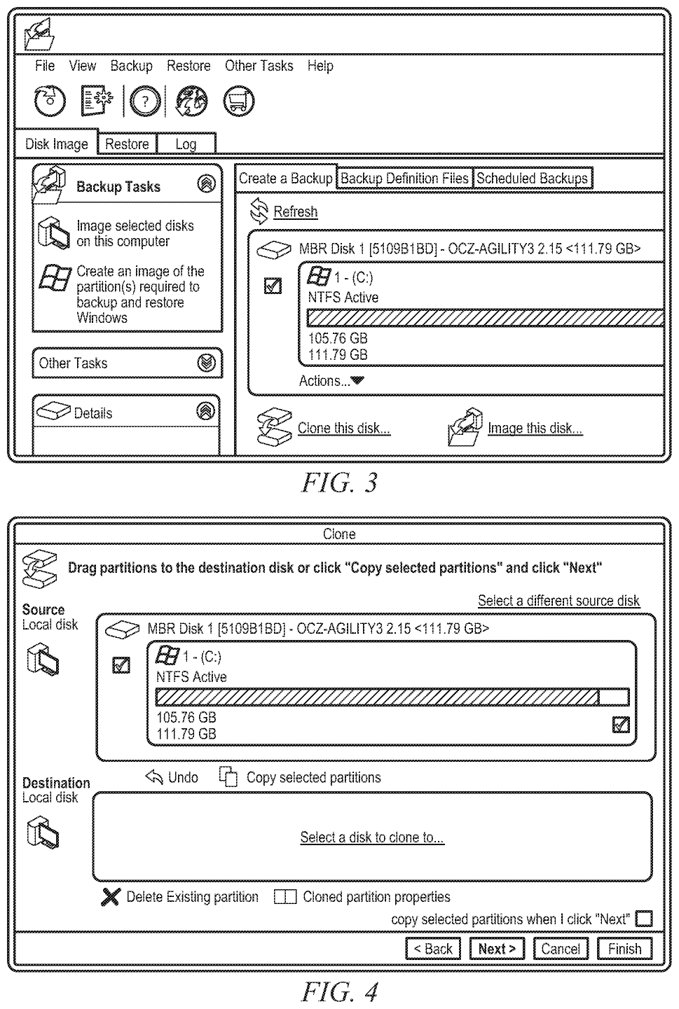

The next step is to begin execution of the cloning program and to instruct the cloning program to clone the existing hard drive, In many cloning programs, a menu with a number or tabs, including a “Disc Image” tab, is displayed once the cloning programs begins execution, Once the “Disc Image” tab is selected by the user, the user identifies and selects the disk upon which the operating system resides (typically, Disk 1, C:\). FIG. 3 is an example screen shot of a cloning program menu once the “Disc Image” tab is selected and the operating system disk is selected, Once the operating system disk has been selected, the cloning program typically provides a number of options, including a “Clone this disk” option, The user then selects the “Clone this disk” option,

Once the “Clone this disk” option has been selected, the cloning program typically provides a menu for the user to select the appropriate destination disk/drive. Fig, 4 is an example screenshot showing the user-selected source disk/drive and for choosing a destination disk/drive. Once the user selects the “Select a disk to clone to” option and selects the appropriate destination disk/drive, the user selects the “Copy selected partitions” tab or other suitable option, depending on the particular cloning program being used.

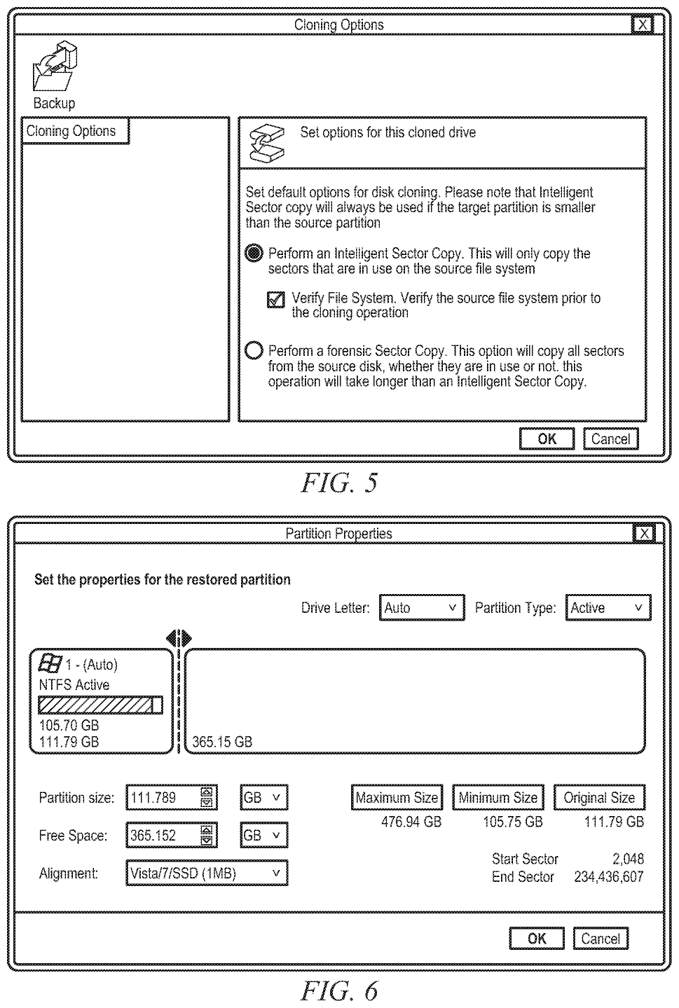

Once the “Copy selected partitions” option has been selected, the cloning program typically provides a cloning options menu. FIG. 5 is an example screenshot showing some available cloning options. The cloning options menu typically provides the option of selecting a “forensic” or “intelligent” sector copy to be performed. A “forensic” sector copy copies every single bit on the source disk/drive, regardless of whether or not the bit is actually in a used sector of the source disk/drive. An “intelligent” sector copy copies only the disk/drive sectors actually in use.

Once the sector copy option has been selected, the cloning program may then ask the user to verify the file system, Once the “Verify File System” option has been selected, and the “OK” button is selected, the cloning program clones the source disk/drive to the destination disk drive.

Once the cloning program has completed the disk/drive cloning process, the cloning program typically displays a Partition Properties screen or menu. FIG. 6 is an example screenshot showing partition properties once the cloning process has been completed. As shown in FIG. 6, the cloning program copied the source disk/drive partition in a one-to-one ratio to the destination disk/drive. Therefore, if the migration operation was performed from a smaller source disk/drive to a larger destination disk/drive, there is a relatively large amount of unused space on the destination disk/drive. As discussed hereinabove, in conventional migration operations, including conventional cloning operations, if the data storage capacity of the destination disk/drive is larger than the data storage capacity of the source disk/drive, the destination disk/drive takes on the characteristics of the source disk/drive, including the smaller data storage capacity of the source disk/drive,

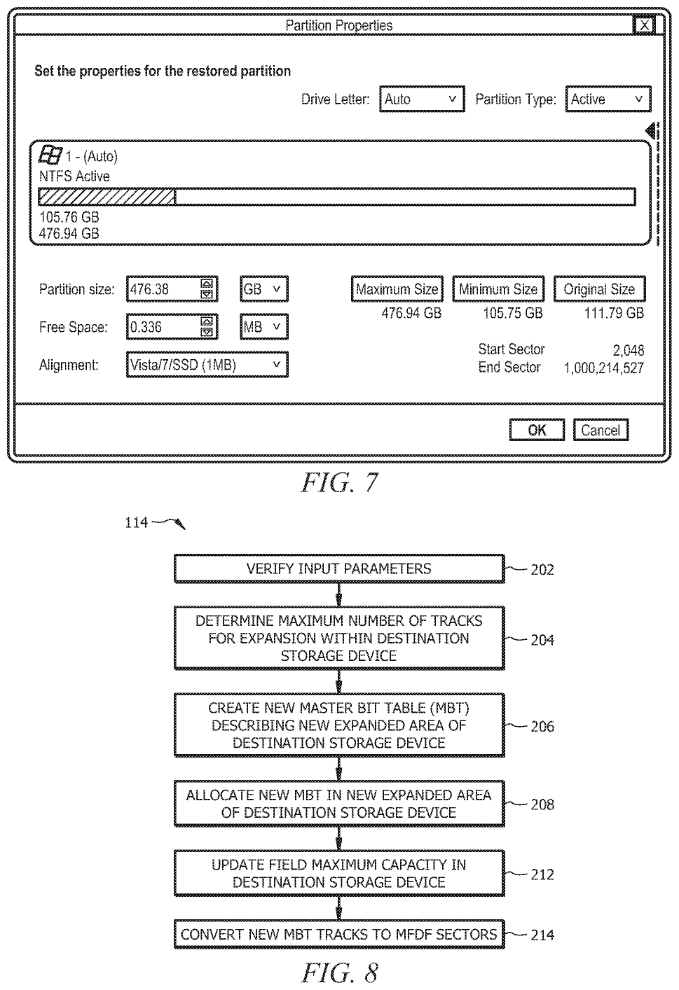

According to an embodiment, a cloning program or other suitable data migration operation provides the option of expanding the data structure of the destination disk/drive to make use of the larger capacity of the destination disk/drive. According to an embodiment, the cloning program or other suitable data migration operation provides a “Maximum Size” option or button. Upon selection of the “Maximum Size” option, the cloning program or other suitable data migration operation automatically resizes the existing destination disk/drive partition to make use of the full amount of available space on the destination disk/drive. FIG. 7 is an example screenshot showing partition properties, with a resized partition, according to an embodiment,

At this point in the process, the source disk/drive has been cloned onto the destination disk/drive and the destination disk/drive partition has been expanded to make use of the full amount of available space on the destination disk/drive. The destination disk/drive then can be tested for proper operation in any suitable manner. For example, for a desktop computer system, the computer system can be turned off, the connections from the source disk/drive removed, and the computer system turned on again. For a laptop computer system, the source disk/drives should be replaced with the destination disk/drive.

According to another embodiment, expanding the data structure of the destination disk/drive to make use of the larger capacity of the destination disk/drive can be performed using an appropriate keyin command, such as an EXPAND pack-id command, where pack-id identifies the pack (i.e., the hard drive memory unit) to be expanded,

According to another embodiment, expanding the data structure of the destination disk/drive to make use of the larger capacity of the destination disk/drive does have a maximum capacity. The maximum track capacity value that is supported is the smaller value of either: 1) the defined capacity for the device (e.g., configured in the “bin” file), or 2) the largest size allowed for the master bit table (MBT) scaling factor of the device, If the pack resides on unit-duplexed devices, the track capacity can be expanded to the maximum capacity of the smaller device.

FIG. 8 is a flow diagram of the EXPAND disk operation step 114 of FIG. 2, according to an embodiment. As discussed herein, the EXPAND disk operation step 114 is a method for dynamically expanding the destination mass storage device as part of the data migration method of FIG. 2, according to an embodiment.

The method 114 includes a step 202 of verifying input parameters. Verifying input parameters includes determining the status of the packid. The destination mass storage device must be in the available for operation (UP) state or the reserved for data migration (RV) state. The destination mass storage device cannot be in the unavailable/inaccessible for operation (DN) state, Also, another EXPAND disk operation cannot be active. The system also must be past a system finish state (i.e., the boot process is complete). If the destination mass storage device is shared, all hosts must be running with the EXPAND disk operation step level of functionality,

Any global locks must be locked to prevent another expansion operation or other facility activity. The unit level lock is set and logical device unit status tables (LDUSTs) are updated with an indicator stating that the expansion is active. This may include incrementing the assign count to prevent changes to the device. At this time, all locks are unlocked. Throughout the EXPAND disk operation process, other I/O operations can be performed to user files.

The method 114 also includes a step 204 of determining the maximum number of tracks for expansion in the destination mass storage device. The maximum number of tracks is returned by a Read Device Characteristics command performed on the disk. This value can be saved in internal tables associated with the destination mass storage device, Once the maximum number of tracks for expansion in the destination mass storage device has been determined and saved, the expansion begins.

For shared destination mass storage devices, communication with other servers actively using the device sends the new track capacity numbers. Upon receipt of the message, the other hosts recognize that an expansion is in progress.

As part of the expansion, the method 114 also includes a step 206 of creating a new master bit table (MBT). Similar to a MFD (multiframe structural frame model) file structure, a new MBT file is created and the Device Allocation Descriptor Tables (DADS) of the new MBT file describe the mass storage space allocated for each of the master bit tables of the destination mass storage device, This new MBT file only describes destination mass storage devices that have been expanded. Another implementation may have a file associated with each device that contains the newly expanded master bit table.

The method 114 also includes a step 208 of allocating a new master bit table in the destination mass storage device. A data bank is acquired to create the new master bit table. The hardware master bit table is read in to the data bank. Any previous padded area at the end of the current hardware master bit table is saved and then cleared. The end of the new master bit table is initialized padding out to the record boundary. The size of the new master bit table is determined, the new master bit table file space is allocated in the new expanded area, and the hardware master bit table is written to the MBT file.

The software master bit table is read in from the source disk, or transferred from memory if the software master bit table resides in a master bit table bank. The software master bit table is updated with the same padding updates made to the hardware master bit table, including the new MBT file space allocation. Internal device tables are updated, indicating where the new file resides, and the read and write lengths of the new file. The software master bit table is written to the MBT file and the bank is released. If the master bit table was in memory, the master bit table valid flag is cleared in a MBT header.

Internal device tables are updated with the new number of tracks, e.g., the determined maximum track capacity value, as discussed hereinabove. For shared destination mass storage devices, an interhost message is sent to the other hosts to create the MBT file DAD entries, update all LDUST MBT fields and track counts, update the equipment summary table track count and update FMSAVL track count on the other hosts.

The method 114 also includes a step 212 of updating the field maximum capacity in the destination mass storage device. The field maximum capacity is updated in the label of the device, or Vol 1, Also, in the label of the device, the device relative location of the new master bit table is updated to reflect the device relative address (DRA). For shared mass storage devices, an interhost message is sent to the other hosts to notify them that the device label, or Vol 1, updates are complete,

For local destination mass storage devices and Multi-Host File Sharing (MHFS) systems, the sector 1 write is the check point. If a system stop occurs before the sector 1 writes complete, the system recovers the destination mass storage device as if the keyin was not performed. If a system stop occurs after the sector 1 writes, the expand destination mass storage device process is completed during file recovery. For shared destination mass storage devices with multiple hosts, the first host to obtain the shared expand pack lock for the destination mass storage device continues the expand destination mass storage device process based on the last interhost message that the host received. If the MBT resides within the file metadata area, the device level lock is locked, thereby protecting this data.

The method 114 also includes a step 214 of converting the master bit table tracks to Master File Directory File (MFDF) sectors. Hardware MBT tracks and software MBT tracks are converted to MFDF sectors, creating data allocation sectors (DASs) as needed.

Data allocation sectors typically are comprised of 28 36-bit words. Each three word group of this sector is thought of as a triplet. Each triplet potentially describes the allocation of one software track of directory space. For example, Word 0 is the software track address of the nth directory track, Word 1 and 2 are 64 bits that represent the 64 sectors in a track (4 bits are padded to each word), and Word 27 points to the next sector or to zero if there are no more sectors in which to point.

Converting the master bit table tracks to MFDF sectors involves reading Vol. 1 to get the location of the first directory track, and updating and writing Vol. 1 with the new maximum capacity and the new master bit table read length. Then, the first 9 tracks (2 sectors) are cleared. An additional 9 track sections are cleared if necessary. A new DAS is set up and written for each cleared section. Sector 1 is then read.

If the destination mass storage device is a sector 1 version 1 destination mass storage device, the device relative addresses in all DASs are converted from word relative addresses to track relative addresses. Sector 0 is converted to the first DAS, setting bits for itself and sector 1. The LDUST cells first_das_offset (LDUDASOFF), das_with_one_sector (LDUDSA), das_with_four_sectors (LDUDS4) are updated. Under sector 1 lock protection, the first_das_offset (S1DASOFF) is updated and sector1_version_nbr (SIVRSN) is updated to version 3.

For shared destination mass storage devices, an interhost message is sent to the other hosts to notify them that DAS and sector 1 updates are complete.

If the MBT resides within the file metadata area and the device lock is locked to protect the MBT data, the device level lock is then released.

The LDUST expand_pack_in_progress flag is cleared. For removable destination mass storage devices, the assign count is decremented.

It will be apparent to those skilled in the art that many changes and substitutions can be made to the embodiments described herein without departing from the spirit and scope of the disclosure as defined by the appended claims and their full scope of equivalents.

1. A method for migrating data from a source mass storage device to a destination mass storage device within a system, wherein the data storage capacity of the destination mass storage device is greater than the data storage capacity of the source mass storage device, wherein the source mass storage device is in an available for operation (UP) state, the method comprising:
changing the state of the destination mass storage device from an unavailable for operation (DN) state to a reserved for data migration (RV) state;
performing a disk copy operation from the source mass storage device to the destination mass storage device, wherein the disk copy operation migrates data from the source mass storage device to the destination mass storage device, and wherein the destination mass storage device takes on the smaller data storage capacity of the source mass storage device;
changing the state of the destination mass storage device from the reserved for data migration (RV) state to an available for operation (UP) state;
changing the state of the source mass storage device from the available for operation (UP) state to an unavailable for operation (DN) state;
performing an Expand Disk operation within the destination mass storage device, wherein the Expand Disk operation expands the size of data storage capacity of the destination mass storage device from the smaller data storage capacity of the source mass storage device; and
removing the source mass storage device from the system.

2. The method as recited in claim 1, wherein performing an Expand Disk operation within the destination mass storage device comprises:
determining a maximum number of tracks within the destination mass storage device to expand the destination mass storage device,
creating a new master bit table (MBT) file based on the maximum number of tracks within the destination mass storage device to expand the destination mass storage device, wherein the new master bit table file describes a new expanded area of the destination mass storage device,
allocating in the new expanded area of the destination mass storage device a new master bit table based on the new master bit table file, wherein the new master bit table includes a plurality of tracks,
updating the field maximum capacity in the destination mass storage device based on the new expanded area of the destination mass storage device, and
converting the plurality of tracks of the new master bit table to a plurality of master file directory file (MFDF) sectors, wherein the plurality of MFDF sectors represent an expanded data storage area within the destination mass storage device,

3. The method as recited in claim 1, wherein migrating data from the source mass storage device to the destination mass storage device is performed without the system being rebooted.

4. The method as recited in claim 1, wherein the source mass storage device is a computer hard drive.

5. The method as recited in claim 1, wherein the destination mass storage device is a computer hard drive.

6. The method as recited in claim 1, wherein the disk copy operation is performed by using a diskcopy (DC) command.

7. A method for dynamically expanding a destination mass storage device during a data migration from a source mass storage device to the destination mass storage device within a system, the method comprising:
determining a maximum number of tracks within the destination mass storage device to expand the destination mass storage device;
creating a new master bit table (MBT) file based on the maximum number of tracks within the destination mass storage device to expand the destination mass storage device, wherein the new master bit table file describes a new expanded area of the destination mass storage device;
allocating in the new expanded area of the destination mass storage device a new master bit table based on the new master bit table file, wherein the new master bit table includes a plurality of tracks;
updating the field maximum capacity in the destination mass storage device based on the new expanded area of the destination mass storage device; and
converting the plurality of tracks of the new master bit table to a plurality of master file directory file (MFDF) sectors, wherein the plurality of MFDF sectors represent an expanded data storage area within the destination mass storage device.

8. The method as recited in claim 7, wherein creating a new master bit table file includes creating device allocation descriptor tables (DADS) of the new master bit table file, and wherein the device allocation descriptor tables describes the new expanded area of the destination mass storage device.

9. The method as recited in claim 8, wherein allocating a new master bit table in the new expanded area of the destination mass storage device includes reading in a hardware master bit table, clearing any padded area at the end of the hardware master bit table, and writing the hardware master bit table to the new master bit table file.

10. The method as recited in claim 9, wherein allocating a new master bit table in the new expanded area of the destination mass storage device includes reading in a software master bit table, updating any padding area updates made to the hardware master bit table, and writing the software master bit table to the new master bit table file.

11. The method as recited in claim 7, wherein creating a new master bit table file includes creating a file associated with the destination mass storage device, and wherein the file associated with the destination mass storage device describes the new expanded area of the destination mass storage device.

12. The method as recited in claim 7, wherein converting the plurality of tracks of the new master bit table to a plurality of master file directory file (MFDF) sectors includes converting a plurality of hardware master bit table tracks to MFDF sectors,

13. The method as recited in claim 7, wherein converting the plurality of tracks of the new master bit table to a plurality of master file directory file (MFDF) sectors includes converting a plurality of software master bit table tracks to MFDF sectors.

14. The method as recited in claim 7, wherein converting the plurality of tracks of the new master bit table to a plurality of master file directory file (MFDF) sectors includes creating a plurality of DASs.

15. The method as recited in claim 14, wherein device relative addresses in the plurality of DASs are converted from word relative addresses to track relative addresses.

16. The method as recited in claim 7, wherein dynamically expanding the destination mass storage device during the data migration from the source mass storage device to the destination mass storage is performed without the system being rebooted.

17. The method as recited in claim 7, wherein the destination mass storage device is a computer hard drive,

18. The method as recited in claim 7, wherein the source mass storage device is a computer hard drive.

19. The method as recited in claim 7, wherein the method is performed by using a diskcopy (DC) command.
